(19) United States
(12) Patent Application Publication
(10) Pub. No.: US 2020/0346210 A1
(43) Pub. Date: Nov. 5, 2020

(54) MICROTITER PLATE

(71) Applicants: InnoME GmbH, Espelkamp (DE); Karlsruher Institut für Technologie, Karlsruhe (DE)

(72) Inventors: Jürgen Hubbuch, Pfinztal (DE); Carsten Radtke, Karlsruhe (DE); Marie-Therese Schermeyer, Berlin (DE); Martin Woywod, Munchen (DE); Daniel Baasner, Minden (DE); Jannik Jungmann, Lohne (DE)

(73) Assignees: InnoME GmbH, Espelkamp (DE); Karlsruher Institut für Technologie, Karlsruhe (DE)

(21) Appl. No.: 16/864,297

(22) Filed: May 1, 2020

(30) Foreign Application Priority Data
May 3, 2019 (DE) 102019003135.0

(51) Int. Cl. B01L 3/00

(52) U.S. Cl. CPC B01L 3/5085; B29C 2045/0094; B01L 2300/0829

(57) ABSTRACT

A microtiter plate, preferably in the form of an injection-molded part composed of plastic, having at least one first and one second fluid chamber, which are designed in particular as measurement chambers and are connected to one another by a fluid channel which, in cross section, is closed on all sides or all the way round, and the fluid channel is assigned a bubble trap, by way of which the movement of air or gas bubbles moving along a top wall, closing the fluid channel upwardly, of the fluid channel, in particular from the first to the second fluid chamber, can be stopped.

### CROSS REFERENCE TO RELATED APPLICATIONS

This application claims priority on and the benefit of German Patent Application No. 10 2019 003 135.0 having a filing date of 3 May 2019.

### BACKGROUND OF THE INVENTION

### Technical Field

The present invention relates to a microtiter plate, preferably in the form of an injection-molded part composed of plastic, having at least one first and one second fluid chamber, which are designed in particular as measurement chambers and are connected to another by a fluid channel which, in cross section, is closed on all sides or all the way round, and to a microtiter plate, preferably in the form of an injection-molded part composed of plastic, having multiple measurement chamber systems which are arranged so as to be distributed over the microtiter plate in grid form, wherein each measurement chamber system has at least one first and one second fluid chamber, which are designed in particular as measurement chambers and are connected to one another via a fluid channel which, in cross section, is closed all the way round, said fluid channel widening upwardly from the first fluid chamber to the second fluid chamber in at least one section thereof, preferably in a section which extends over the entire length of the fluid channel, wherein the first and second fluid chambers are each upwardly closed by a top wall, and wherein the inner height of the first fluid chamber is smaller than the inner height of the second fluid chamber.

### Prior Art

Microtiter plates having multiple fluid chambers for samples for testing can be used not only but inter alia for determining the concentration of particular molecules in a liquid sample by means of photometric measurement methods. Here, microtiter plates having multiple measurement chamber systems which are arranged so as to be distributed over the microtiter plate in grid form, for which each measurement chamber system has fluid chambers of different height that are connected to one another by a channel structure, with the result that detection light which is in each case emitted through the fluid chambers passes through different sample path lengths of one and the same sample, are also known. Using the Lambert-Beer law, the concentration of the molecular concentration contained in the sample can then be inferred by analysis of the absorption values which absorption values differ owing to the different path lengths.

### BRIEF SUMMARY OF THE INVENTION

It is an object of the present invention to further develop the microtiter plates mentioned in the introduction.

Said object is achieved by a microtiter plate, preferably in the form of an injection-molded part composed of plastic, having at least one first and one second fluid chamber, which are designed in particular as measurement chambers and are connected to another by a fluid channel which, in cross section, is closed on all sides or all the way round, wherein the fluid channel is assigned a bubble trap, by way of which the movement of air or gas bubbles which move along a top wall, closing the fluid channel upwardly, of the fluid channel, in particular from the first to the second fluid chamber, can be stopped, and by a microtiter plate, preferably in the form of an injection-molded part composed of plastic, having multiple measurement chamber systems which are arranged so as to be distributed over the microtiter plate in grid form, wherein each measurement chamber system has at least one first and one second fluid chamber, which are designed in particular as measurement chambers and are connected to one another via a fluid channel which, in cross section, is closed all the way round, said fluid channel widening upwardly from the first fluid chamber to the second fluid chamber in at least one section thereof, preferably in a section which extends over the entire length of the fluid channel, wherein the first and second fluid chambers are each upwardly closed by a top wall, and wherein the inner height of the first fluid chamber is smaller than the inner height of the second fluid chamber, wherein the breadth of the fluid channel in the at least one section narrows from the first to the second fluid chamber.

A microtiter plate according to the invention accordingly has at least one first and one second fluid chamber, which are connected to another by a fluid channel which, in cross section, is closed on all sides or all the way round, wherein the fluid channel is assigned a bubble trap, by way of which the movement of air or gas bubbles which move along a top wall, closing the fluid channel upwardly, of the fluid channel, in particular from the first to the second fluid chamber, can be stopped.

In this way, it is achieved for example, in particular if one or both fluid chambers are measurement chambers into which it is possible to introduce samples for measuring properties thereof, that any air bubbles interfering with such measurements, which, during the use of the microtiter plate, can outgas from the fluid or the sample and are situated in the fluid channel, are prevented from migrating into one of the two fluid chambers and, there, affecting the measurement. It would thus be possible, for example, for air bubbles which outgas in the first fluid chamber and then migrate in the direction of the second fluid chamber via the fluid channel to be stopped from moving further at the bubble trap, with the result that said air bubbles do not interfere with in particular optical, such as for example photometric, measurements in the second fluid chamber.

Within the scope of the present application, measurement chambers are accordingly in particular fluid chambers which are provided such that measurements can be carried out for fluid situated therein or for sample liquid situated therein.

A microtiter plate according to the invention also has, as an extension of the above microtiter plate, multiple measurement chamber systems which are arranged so as to be distributed over the microtiter plate in grid form, of which each has in each case at least one such first and second fluid chamber, which are likewise preferably designed in each case as a measurement chamber and are connected to one another via a fluid channel, already mentioned above, which, in cross section, is closed all the way round, said fluid channel widening (in terms of its inner height) upwardly from the first fluid chamber to the second fluid chamber in at least one section, preferably in a section which extends over the entire length of the fluid channel. Here, the first and second fluid chambers are each upwardly closed by a top wall, wherein the inner height of the first fluid chamber is smaller than the inner height of the second fluid chamber. The microtiter plate is characterized in that the breadth of the fluid channel, widening (in terms of inner height), in this section or preferably over the entire length of the fluid channel narrows from the first to the second fluid chamber.

In this way, according to the invention, by reduction of pressure differences, optimization of the flow between the two fluid chambers is achieved such that, when the measurement chamber system is filled, the formation of turbulent flows, which promote the outgassing of air bubbles, is prevented or limited.

The features described above, and all the features described below, of a microtiter plate according to the invention may preferably be combined with one another. In particular, all the features below may be combined both with a microtiter plate as described above and with a microtiter plate having multiple measurement chamber systems. It may thus be provided for example that the aforementioned bubble trap is assigned to the fluid channel of each measurement chamber system of the multititer microtiter plate having multiple measurement chamber systems that connects the first and second fluid chambers.

As far as the bubble trap already mentioned is concerned, the top wall of the fluid channel may comprise a recess in the top wall of the fluid channel, which recess is open toward the fluid channel interior and can then be entered by an air or gas bubble and, there, trapped or held.

Preferably, as seen in cross section, such a recess, in the region of the top wall in which it is arranged, can extend over the entire breadth of the top wall.

As an alternative to a recess in the top wall, the bubble trap may also comprise a downwardly directed projection or web, which is connected to the top wall of the fluid channel and is in particular integrally formed on the top wall. This is preferably of such a size that air bubbles which move along the top wall are held between the projection or web and the top wall or are stopped by the web.

Here, the web preferably covers—in relation to the cross section of the fluid channel—a sub-cross-sectional surface of the entire fluid channel cross-sectional surface that is arranged in the upper region of the channel.

In particular, the web can sealingly cover the sub-cross-sectional surface to the top wall of the fluid channel and to lateral walls of the channel, so that, to the sides of and above the web, no air or gas bubbles are able to move past said web. As far as the fluid channel is concerned, this widens upwardly from the first to

the second fluid chamber in the at least one section such that, in said section, the inner side (facing the interior of the channel) of the top wall of said fluid channel extends so as to be inclined with respect to the horizontal.

Where reference is made in the present application to “horizontal” and “upward” or “upwardly” or “downward” or “downwardly”, this information relates to an intended use of the microtiter plate in which the latter is positioned with a horizontal orientation on a horizontal support surface, such as for example on a table, etc.

Preferably, the fluid channel may be connected at one end via a connection opening with a relatively small height to the first fluid chamber and at another end via a connection opening with a relatively great height to the second fluid chamber.

Here, the inner height of the first fluid chamber may correspond to the height of the connection opening connecting the first fluid chamber to the fluid channel, and the inner height of the second fluid chamber may correspond to the height of the connection opening connecting the second fluid chamber to the fluid channel.

In a further particularly preferred configuration of the invention, the first and second fluid chambers are each upwardly closed by a or their top wall, wherein the inner height of the first fluid chamber is smaller than the inner height of the second fluid chamber, in particular such that the inner height of the first fluid chamber corresponds to the height of the connection opening connecting the first fluid chamber to the fluid channel and the inner height of the second fluid chamber corresponds to the height of the connection opening connecting the second fluid chamber to the fluid channel.

As far as the recess of the bubble trap in the top wall of the fluid channel is concerned, the height of the recess at the highest point thereof in the top wall may preferably be greater than the maximum height of the inner side of the top wall along the fluid channel.

Alternatively or additionally, the height of the recess at the highest point thereof in the top wall may be greater than the height of the aforementioned connection opening with relatively great height, which connects the fluid channel to the second fluid chamber.

Furthermore alternatively or additionally, the height of the recess at the highest point thereof may be greater than the inner height of the second fluid chamber.

Preferably, the microtiter plate, in particular each measurement system, also has, in addition to the first and second fluid chambers, at least one upwardly open inlet (fluid) chamber, which is connected to the second fluid chamber by means of a further (separate) fluid channel, the latter in particular, in cross section, being closed on all sides, and via which sample fluid is able to be supplied.

Furthermore preferably, the microtiter plate, in particular each measurement chamber system, also has, in addition to the first and second fluid chambers, at least one upwardly open outlet (fluid) chamber, which is connected to the first fluid chamber by a further (separate) fluid channel, the latter, in cross section, being closed on all sides, and via which sample fluid is able to be removed from the measurement chamber system. Moreover, when the measurement chamber system is filled, air which is situated in the measurement chamber system can escape through said outlet chamber.

Furthermore preferably, the microtiter plate, in particular each measurement system, has at least one third fluid chamber, which is designed in particular as a measurement chamber and is upwardly closed by a top wall, wherein the inner height of the third fluid chamber is greater than the inner height of the second fluid chamber, and wherein the third fluid chamber is connected to the second fluid chamber by a further (separate) fluid channel, which, in cross section, is closed on all sides and which widens upwardly from the second fluid chamber to the third fluid chamber in at least one section, preferably in a section which extends over the entire length of the fluid channel.

Here, the breadth of the further fluid channel, which widens in the at least one section, may—in a manner similar to that of the fluid channel connecting the first and second fluid chambers—narrow in said section from the second to the third fluid chamber. Insofar as provision is made of an inlet chamber in this embodiment, the latter would preferably be connected to the third fluid chamber and not to the second fluid chamber.

As far as the top walls of the first and second fluid chambers and, if appropriate, of the third fluid chamber are concerned, these may preferably each be adjacent to the surroundings of the microtiter plate, consist of material transparent to light and each have the same thickness.

Furthermore, the top walls of the first, of the second and, if appropriate, of the third fluid chamber may preferably have an inner side which in each case faces the interior of the respective fluid chamber, and an outer side which is adjacent to the outer surroundings of the microtiter plate and extends in particular parallel to the inner side, wherein the in each case equal thickness of the top wall relates to the spacing of the outer side to the inner side or corresponds thereto.

Expediently, the microtiter plate has a base plate (oriented in a horizontal plane when the microtiter plate is used as intended), on which the first, second and, if appropriate, the third fluid chamber, the fluid channel(s) connecting the fluid chambers, and if appropriate the inlet chamber and if appropriate the outlet chamber are arranged next to one another in a common (horizontal) plane.

Preferably, the base plate in each case forms the respective bottom wall of the first, second and, if appropriate, third fluid chamber, of the fluid channel(s) connecting the fluid chambers, and if appropriate of the inlet chamber and if appropriate of the outlet chamber.

The inner side, facing the interior of the respective fluid chamber, and/or the outer side, adjacent to the outer surroundings of the microtiter plate, of the top wall of the first, the second and, if appropriate, the third fluid chamber may in this case extend parallel to the base plate of the microtiter plate or parallel to the outer side, adjacent to the surroundings, of the base plate.

### BRIEF DESCRIPTION OF THE DRAWINGS

Further features of the present invention will emerge from the appended patent claims, from the following description of preferred exemplary embodiments and from the appended drawings.

In the drawings:

FIG. 1 shows an oblique view of a microtiter plate according to the invention with a multiplicity of measurement systems arranged in grid form;

FIG. 2 shows a plan view of a single measurement system as per FIG. 1;

FIG. 3 shows a cross section along the section line B-B in FIG. 2; and

FIG. 4 shows a cross section along the section line A-A in FIG. 2.

### DETAILED DESCRIPTION OF PREFERRED EMBODIMENTS

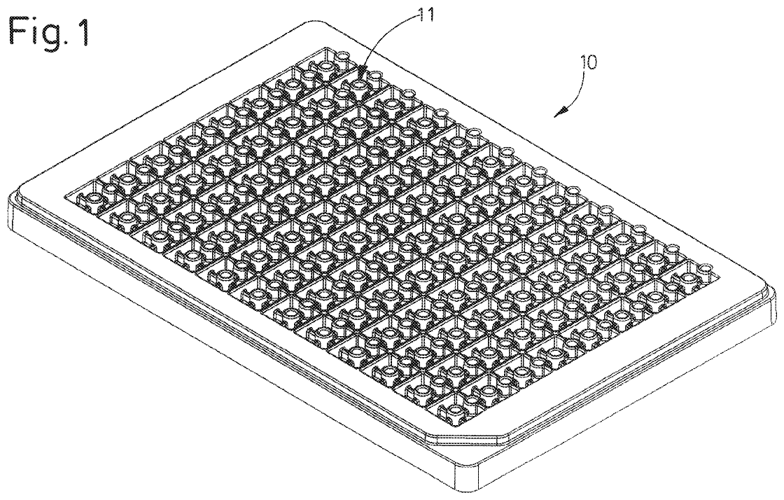

FIG. 1 shows a microtiter plate 10, which is preferably manufactured as an injection-molded part from plastic.

The microtiter plate 10 has a multiplicity of measurement systems 11. The measurement systems 11 are arranged so as to be distributed over the microtiter plate 10 in grid form. As is known in the prior art, such microtiter plates 10, in terms of their dimensions and their number of measurement systems 11, are generally standardized so as to allow simple incorporation thereof into existing automated measurement processes or measurement apparatuses.

In the present case, 8×12 measurement systems 11 are present. However, it goes without saying that various other arrangements in grid form, also having more or fewer measurement systems, are possible.

Each of the measurement chamber systems 11 has multiple, in the present case four (although there may be more or fewer), fluid chambers 13a, 13b, 13c and 13d, which are connected to one another via fluid channels 12a, 12b and 12c (closed on all sides in cross section) and are designed as measurement chambers.

In the present case, the fluid chambers 13a-13d are, by way of the fluid channels 12a, 12b and 12c, arranged in the manner of a “series connection” in series one behind the other or successively.

Accordingly, in each case (via the fluid channels 12a and 12c, respectively) the fluid chamber 13a, which is first in the series, is connected only to the fluid chamber 13b, which is the next one in the series, and the fluid chamber 13d, which is last in the series, is connected only to the fluid chamber 13c, which is the preceding one in the series.

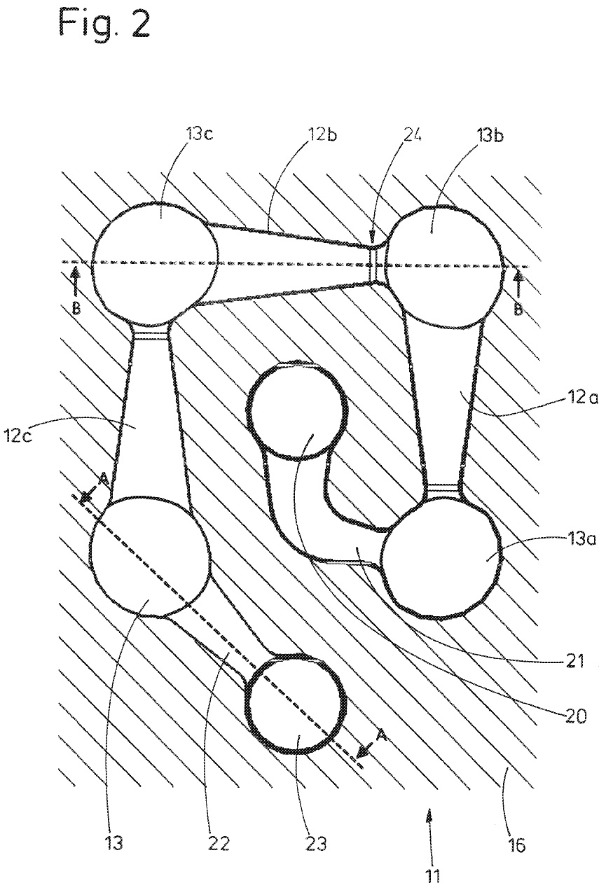

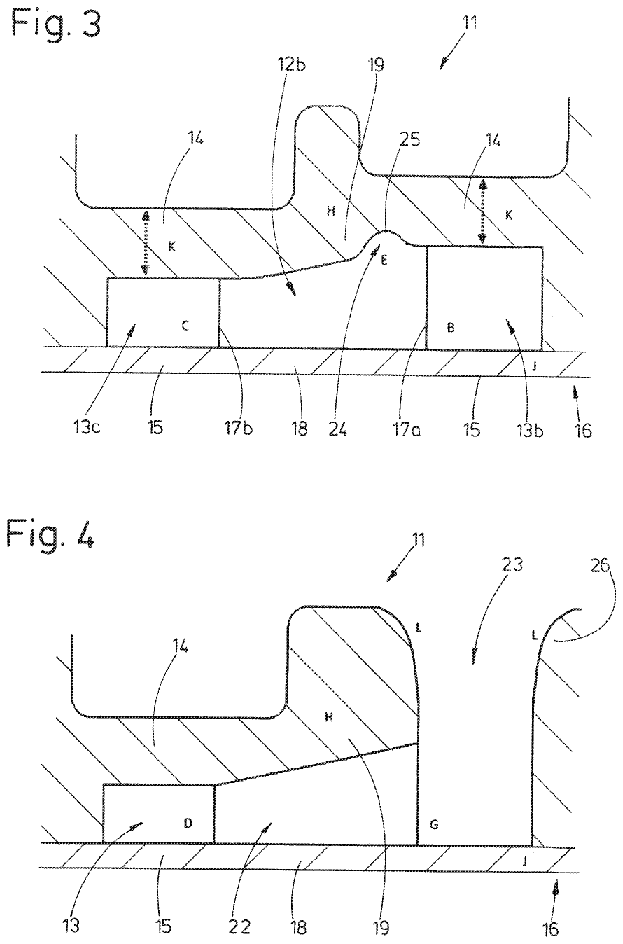

The fluid chambers 13b and 13c, which are the middle ones in the series, are connected via the fluid channels 12a or 12b or 12c firstly to one another and secondly to the in each case preceding fluid chamber 13a or next fluid chamber 13d, cf. FIG. 2.

Each of the fluid chambers 13a-13d is upwardly closed and downwardly closed, specifically by in each case one top wall 14 and one bottom wall 15, respectively.

The inner heights of the fluid chambers 13a-13d, specifically in the present case the spacing of the inner side, facing the interior of the respective fluid chamber 13a-13d, of the respective top wall 14 to the inner side, facing the interior of the respective fluid chamber 13a-13d, of the respective bottom wall 15, in the series of the successive fluid chambers 13a-13d, starting with the fluid chamber 13a, via the fluid chamber 13b and the fluid chamber 13c, to the fluid chamber 13d, become smaller in each case.

Accordingly, for each pair 13a, 13b and 13b, 13c and 13c, 13d of fluid chambers 13a-13d connected to one another via a corresponding fluid channel 12a-12c, it is the case that the inner height of the fluid chamber 13a-13d which is in each case the preceding one in the series is greater than the inner height of the fluid chamber 13a-13d which is in each case the next one in the series.

The bottom wall 15 of each fluid chamber 13a-13d is in the present case in each case formed by a common base plate 16 or a corresponding wall of the microtiter plate 10.

The top walls 14 of the individual fluid chambers 13a-13d are formed by a (different) common wall of the microtiter plate 10 and are correspondingly connected to one another integrally so as to merge into one another.

For each pair of fluid chambers 13a, 13b; 13b, 13c; 13c, 13d it is furthermore the case that the fluid channel 12a, 12b or 12c in each case connecting the respective pair is connected at one end via a connection opening 17a with a relatively great height to the fluid chamber 13a-13d which is the preceding one in the series and at its other end via a connection opening 17b with a relatively small height to the fluid chamber 13a-13d which is in each case the next one in the series.

Here, the inner height of the in each case preceding fluid chamber 13a-13d with relatively great height corresponds to the height of the corresponding connection opening 17a, and the inner height of the fluid chamber 13a-13d which is the next one in the series corresponds to the height of the corresponding connection opening 17b.

The connection channels 12a, 12b, 12c (closed on all sides in cross section) are each downwardly closed by bottom walls 18 and upwardly closed by top walls 19. Here, the bottom walls 18, just like the bottom walls 15 of the fluid chambers 13a-13d, are formed by the base plate 16. The top walls 19 of the fluid channels 12a, 12b, 12c integrally adjoin the top walls 14 of the fluid chambers 13a-13d.

The top walls 19 of the fluid channels 12a, 12b, 12c extend so as to be inclined with respect to the horizontal. Here, for each pair of fluid chambers 13a, 13b; 13b, 13c; and 13c, 13d, which are successive in the series, it is the case that the inner height of the respective fluid channel 12a, 12b, 12c, that is to say the spacing of the respective inner side of the top wall 19 to the respective bottom wall 18, is greater in the region in which the respective fluid channel 12a, 12b, 12c adjoins the connection opening 17a than at the other end of the fluid channel 12a, 12b, 12c, at which the fluid channel 12a, 12b, 12c adjoins the connection opening 17b.

Between the two connection openings 17a, 17b, the inner side of the top wall 19 extends along the respective fluid channel 12a-12c at least sectionally in an obliquely downwardly inclined manner, with the result that the corresponding fluid channel 12a-12c narrows in this direction or widens in the opposite direction. In the present case, the respective fluid channel 12a-12c, apart from a region in which a bubble trap (described in more detail later) is arranged, widens (in the opposite direction) substantially over its entire respective length, specifically also continuously and with a constant upward slope.

It is expressly within the scope of the invention that the respective fluid channel 12a-12c widens only in a respective sub-section of the respective fluid channel 12a-12c (that is to say not along the entire length of the fluid channel 12a-12c) or in multiple (shorter) sub-sections. In this case, it is not necessary for the respective fluid channel 12a-12c to widen with a constant slope, but rather variable or non-constant widening upward slopes are conceivable. Moreover, discontinuities can also occur in the widening.

Each measurement chamber system 11 moreover has an inlet chamber 20, which is connected via a fluid channel 21 to the fluid chamber 13a with greatest inner height.

Furthermore, each measurement chamber system 11 has an outlet chamber 23, which is connected via a fluid channel 22 to the fluid chamber 13d with smallest inner height, which is last in the series of the fluid chambers 13a-13d.

Each measurement chamber system 11 can be filled via the inlet chamber 20 with sample liquid, which then flows via the fluid channel 21 into the fluid chamber 13a and via the further channels 12a, 12b, 12c into the fluid chambers 13b, 13c and 13d, which follow in the series, and finally via the fluid channel 22 into the outlet chamber 23.

With a corresponding filling, the individual fluid chambers 13a-13d are filled completely, that is to say until the height of the fluid level corresponds to the inner height thereof.

Owing to the different inner heights of the different fluid chambers 13a-13d, for light beams which are emitted vertically into the fluid chambers 13a-13d from above through the transparent top walls 14 during photometric measurements, different optical path lengths are established in the respective sample liquid of the respective fluid chamber 13a-13d.

Using the Lambert-Beer law, the concentration of the molecular concentration contained in the sample can then be inferred by analysis of the absorption values of the sample liquid, which absorption values differ owing to the different path lengths.

It is possible, in particular during the filling of the measurement chamber systems 11, for turbulent flows to be formed, which promote the escape of air bubbles from the respective sample liquid, which air bubbles can in turn interfere in particular with optical or photometric measurements.

One provision of the invention is the minimization of such flows. For this purpose, the fluid channels 12a, 12b, 12c, in each case in terms of their breadth, are formed to widen from the fluid chamber 13a-13d with greater inner height, which is the preceding one in the series of the fluid chambers 13a-13d, to the next fluid chamber 13a-13d or to narrow in the reverse direction, cf. the plan view in FIG. 2. In this way, pressure differences in the measurement chamber system 11 are reduced.

According to a further particular feature, provision is made for the trapping of air bubbles, should these be formed and situated in the respective fluid channel 12a-12c. For this purpose, bubble traps are respectively positioned in the fluid channels 12a-12c. In the present exemplary embodiment, said bubble traps are recesses 25 which are arranged in the respective top wall 19 and which face downward toward the interior of the respective fluid channel 12a-12c.

In the present exemplary embodiment, said recesses 25 extend over the entire breadth of the respective top wall 19, cf. FIG. 2.

Moreover, in the present case, the recess 25 is in each case arranged such that the highest point thereof in the top wall 19 is above the maximum inner height of the respective fluid channel 12a-12c along the fluid channel 12a-12c.

It is also the case that, in the present case, the height of the recess 25 at the highest point is in each case greater than the height of the connection opening 17a, which adjoins the respective fluid chamber of greater inner height of the fluid chambers 13a-13d of the respective pair of fluid chambers 13a, 13b; 13b, 13c; 13c, 13d between which the respective fluid channel 12a-12c extends.

Finally, the height of said recess 25 at the highest point is also greater than the inner height of the in each case other fluid chamber 13a-13d with smaller inner height of the respective pair of fluid chambers 13a, 13b; 13b, 13c; 13c, 13d.

Insofar as, for example during or after the filling of the measurement chamber system 11 with the sample liquid, air bubbles exiting the fluid chamber 13a-13d with smaller inner height migrate into the fluid channel 12a-12c and then, owing to the obliquely extending inner side of the top wall 19 of the respective fluid channel 12a-12c, migrate on said inner side toward the other fluid chamber 13a-13d, with greater inner height, of the respective pair of fluid chambers 13a, 13b; 13b, 13c; 13c, 13d, said air bubbles are trapped in the recess 25 of the bubble trap 24 on their path along the inner side of the top wall 19. Accordingly, said air bubbles are then unable to enter the respective fluid chamber 13a-13d with greater inner height and, there, distort the measurement results.

As an alternative to such recesses 25 in the top wall 19, it is also possible for example for provision to be made of downwardly directed webs which are attached to the top wall 19 (in particular the inner side thereof), in particular are integrally formed thereon, and can in a similar manner stop air bubbles continuing along their path.

A further particular feature of the invention is that the top walls 14 (with their outer side adjacent to the surroundings) of the respective fluid chambers 13a-13d each have the same thickness in order to configure in an identical manner the optical path lengths through said top walls 14, that is to say within the respective top wall 14, for emitted detection light. In this way, it is possible, if appropriate, to dispense with calibration measurements.

Finally, a further particular feature is the design of the inlet and outlet chambers 20 and 23, respectively.

Both the upwardly open inlet chamber 20 and the upwardly open outlet chamber 23 are in each case designed such that the lateral walls 26 thereof or the interior, enclosed by the lateral walls 26, thereof slightly widen(s) upwardly, specifically perpendicular to the bottom plate 16. This allows different tips and cannulas of a very wide variety of diameters to be placed on the inlet or outlet chamber 20 or 23, with the result that simple filling and emptying of the system is possible.

The fact that, in the present case, the inlet and outlet chambers 20 and 23, respectively, are also of identical design means that, theoretically, it would also be possible for the respective measurement system 11 to be filled in the manner which is the reverse of the designated manner, specifically in that, instead of the inlet chamber 20, the respective outlet chamber 23 is filled with the sample liquid, and, at a later stage, the respective inlet chamber 20 is used for emptying the measurement chamber system 11.

### LIST OF REFERENCE SIGNS

10 Microtiter plate
11 Measurement system
12a Fluid channel
12b Fluid channel
12c Fluid channel
13a Fluid chamber
13b Fluid chamber
13c Fluid chamber
13d Fluid chamber
14 Top wall
15 Bottom wall
16 Base plate
17a Connection opening
17b Connection opening
18 Bottom wall
19 Top wall
20 Inlet chamber
21 Fluid channel
22 Fluid channel
23 Outlet chamber
24 Bubble trap
25 Recess
26 Lateral wall

What is claimed is:

1. A microtiter plate, preferably in the form of an injection-molded part composed of plastic, having at least one first and one second fluid chamber (13a-d), which are designed in particular as measurement chambers and are connected to another by a fluid channel (12a-c) which, in cross section, is closed on all sides or all the way round, wherein the fluid channel (12a-c) is assigned a bubble trap (24), by way of which the movement of air or gas bubbles which move along a top wall, closing the fluid channel (12a-c) upwardly, of the fluid channel, in particular from the first to the second fluid chamber, can be stopped.

2. A microtiter plate, preferably in the form of an injection-molded part composed of plastic, in particular as claimed in claim 1, having multiple measurement chamber systems (11) which are arranged so as to be distributed over the microtiter plate in grid form, wherein each measurement chamber system (11) has at least one first and one second fluid chamber (13a-d), which are designed in particular as measurement chambers and are connected to one another via a fluid channel (12a-c) which, in cross section, is closed all the way round, said fluid channel widening upwardly from the first fluid chamber (13a-d) to the second fluid chamber (13a-d) in at least one section thereof, preferably in a section which extends over the entire length of the fluid channel, wherein the first and second fluid chambers (13a-d) are each upwardly closed by a top wall, and wherein the inner height of the first fluid chamber (13a-d) is smaller than the inner height of the second fluid chamber (13a-d), wherein the breadth of the fluid channel (12a-c) in the at least one section narrows from the first to the second fluid chamber (13a-d).

3. The microtiter plate as claimed in claim 1, wherein the bubble trap (24) comprises a recess (25) in the top wall of the fluid channel (12a-c), which recess is open toward the fluid channel interior and can be entered by an air or gas bubble.

4. The microtiter plate as claimed in claim 3, wherein, in cross section, the recess (25), in the region of the top wall in which it is arranged, extends over the entire breadth of the top wall.

5. The microtiter plate as claimed in claim 1, wherein the bubble trap (24) comprises a downwardly directed projection or web, which is connected to the top wall of the fluid channel (12a-c) and is in particular integrally formed on the top wall.

6. The microtiter plate as claimed in claim 4, wherein the web covers a sub-cross-sectional surface of the entire fluid channel cross-sectional surface that is arranged in the upper region of the channel. The microtiter plate as claimed in claim 6, wherein the web sealingly covers the sub-cross-sectional surface to the top wall of the fluid channel (12a-c) and to lateral walls of the fluid channel (12a-c), so that, to the sides of and above the web, no air or gas bubbles are able to move past said web.

8. The microtiter plate as claimed in claim 1, wherein the fluid channel (12a-c) widens upwardly from the first to the second fluid chamber (13a-d) at least in a section thereof, preferably in a section which extends over the entire length of the fluid channel, such that, in said section, the inner side of the top wall of said fluid channel extends so as to be inclined to the horizontal.

9. The microtiter plate as claimed in claim 1, wherein the fluid channel (12a-c) is connected at one end via a connection opening with a relatively small height to the first fluid channel (13a-d) and at another end via a connection opening with a relatively great height to the second fluid chamber (13a-d).

10. The microtiter plate as claimed in claim 9, wherein the inner height of the first fluid chamber (13a-d) corresponds to the height of the connection opening connecting the first fluid chamber (13a-d) to the fluid channel (12a-c), and the inner height of the second fluid chamber (13a-d) corresponds to the height of the connection opening connecting the second fluid chamber (13a-d) to the fluid channel (12a-c).

11. The microtiter plate as claimed in claim 10, wherein the first and second fluid chambers (13a-d) are each upwardly closed by a top wall, wherein the inner height of the first fluid chamber (13a-d) is smaller than the inner height of the second fluid chamber (13a-d), in particular such that the inner height of the first fluid chamber (13a-d) corresponds to the height of the connection opening connecting the first fluid chamber (13a-d) to the fluid channel (12a-c) and the inner height of the second fluid chamber (13a-d) corresponds to the height of the connection opening connecting the second fluid chamber (13a-d) to the fluid channel (12a-c).

12. The microtiter plate as claimed in claim 3, wherein the height of the recess (25) of the bubble trap (24) at the highest point thereof in the top wall is greater than the maximum height of the inner side of the top wall along the fluid channel (12a-c), and/or in that the height of the recess (25) at the highest point thereof in the top wall is greater than the height of the connection opening with relatively great height, which connects the fluid channel (12a-c) to the second fluid chamber (13a-d), and/or in that the height of the recess (25) at the highest point thereof is greater than the height of the second fluid chamber (13a-d).

13. The microtiter plate as claimed in claim 2, wherein the microtiter plate, in particular each measurement system (11), also has, in addition to the first and second fluid chambers (13a-d), at least one upwardly open inlet chamber, which is connected to the measurement system (11), in particular to the fluid chamber (13a-d) with greatest inner height, by means of a further separate fluid channel (12a-c), the latter in particular, in cross section, being closed on all sides, and via which sample fluid is able to be supplied.

14. The microtiter plate as claimed in claim 2, wherein the microtiter plate, in particular each measurement system (11), also has, in addition to the first and second fluid chambers (13a-d), at least one upwardly open outlet chamber, which is connected to the measurement system (11), in particular to the first fluid chamber (13a-d) with smallest inner height, by a further separate fluid channel (12a-c), the latter, in cross section, being closed on all sides, and via which sample fluid is able to be removed from the measurement system (11).

15. The microtiter plate as claimed in claim 2, wherein the microtiter plate, in particular each measurement system (11), has at least one third fluid chamber (13a-d), which is designed in particular as a measurement chamber and is upwardly closed by a top wall, wherein the inner height of the third fluid chamber (13a-d) is greater than the inner height of the second fluid chamber (13a-d), wherein the third fluid chamber (13a-d) is connected to the second fluid chamber (13a-d) by a further (separate) fluid channel (12a-c), which, in cross section, is closed on all sides and which widens upwardly from the second fluid chamber (13a-d) to the third fluid chamber (13a-d) in at least one section thereof, preferably in a section which extends over the entire length of the fluid channel.

16. The microtiter plate as claimed in claim 15, wherein the breadth of the further fluid channel (12a-c), which widens upwardly in the at least one section, narrows in said section from the second to the third fluid chamber.

17. The microtiter plate as claimed in claim 1, wherein the top walls of the first and second fluid chambers (13a-d) and, if appropriate, of the third fluid chamber (13a-d) are each adjacent to the surroundings of the microtiter plate, consist of material transparent to light and each have the same thickness.

18. The microtiter plate as claimed in claim 17, wherein the top walls of the first, of the second and, if appropriate, of the third fluid chamber (13a-d) have an inner side which in each case faces the interior of the respective fluid chamber (13a-d), and an outer side which is adjacent to the outer surroundings of the microtiter plate and extends in particular parallel to the inner side, wherein the in each case equal thickness of the top wall relates to the spacing of the outer side to the inner side or corresponds thereto.

19. The microtiter plate as claimed in claim 1, wherein the microtiter plate has a base plate oriented in a horizontal plane when the microtiter plate is used as intended, on which the first, second and, if appropriate, the third fluid chamber (13a-d), the fluid channel(s) (12a-c) connecting the fluid chambers (13a-d), and if appropriate the inlet chamber and if appropriate the outlet chamber are arranged next to one another in a common horizontal plane.

20. The microtiter plate as claimed in claim 19, wherein the base plate in each case forms the respective bottom wall of the first, second and, if appropriate, third fluid chamber (13a-d), of the fluid channel(s) (12a-c) connecting the fluid chambers, and if appropriate of the inlet chamber and if appropriate the outlet chamber.

21. The microtiter plate as claimed in claim 19, wherein the inner side, facing the interior of the respective fluid chamber, and/or the outer side, adjacent to the outer surroundings of the microtiter plate, of the top wall of the first, the second and, if appropriate, the third fluid chamber (13a-d) extend(s) parallel to the base plate of the microtiter plate or parallel to the outer side, adjacent to the surroundings, of the base plate.
